(19) United States
(12) Patent Application Publication
(10) Pub. No.: US 2026/0321148 A1
(43) Pub. Date: Oct. 15, 2026

(54) SYSTEM AND METHOD FOR MANAGING WEATHER INFORMATION IN AN AIRCRAFT

(71) Applicant: Airbus Operations (S.A.S.), Toulouse (FR)

(72) Inventors: Thibault Molinier, Toulouse (FR); Dorian Goncalves Dos Santos, Blagnac (FR)

(73) Assignee: Airbus Operations (S.A.S.), Toulouse (FR)

(21) Appl. No.: 19/629,595

(22) Filed: Mar. 26, 2026

(30) Foreign Application Priority Data
Apr. 10, 2025 (FR) FR2503826

(51) Int. Cl. G08G 5/76; G08G 5/23

(52) U.S. Cl. CPC G08G 5/76; G08G 5/23

(57) ABSTRACT

A system and method for managing weather information in an aircraft includes a management computer of a weather radar configured to determine weather information based on data received from the weather radar and to send commands to display the weather information, in accordance with an ARINC 708 communication protocol. A converter is connected to the weather radar management computer and to a display system and configured to receive weather information display commands sent by the weather radar management computer, to retransmit the weather information display commands to the display system, in accordance with the ARINC 708 communication protocol, to encapsulate the weather information display commands in data frames compliant with an Ethernet communication protocol, and to send the data frames to a user system on-board the aircraft.

### TECHNICAL FIELD

The disclosure herein relates to the field of weather information display in an aircraft.

### BACKGROUND

A transport aircraft generally comprises at least one weather radar intended to monitor the weather conditions at the front of the aircraft. In one example of a system 40 for displaying weather information from the prior art, as shown in FIG. 2, the aircraft comprises two weather radars 12a, 12b. Each weather radar is coupled to a management computer 14a, 14b of the weather radar, which receives data from the weather radar and consequently determines weather information display commands. The weather radar management computer 14a, 14b sends these weather information display commands via a communication link to a display system 18 in the aircraft cockpit, using a communication protocol in accordance with the ARINC 708A standard. In the example shown in the figure, each management computer 14a, 14b sends the display commands via a link 16a, 16b, corresponding to a weather display intended for a pilot of the aircraft, and via a link 17a, 17b, corresponding to a weather display intended for a co-pilot of the aircraft.

The transmission of weather information display commands in accordance with a communication protocol in accordance with the ARINC 708A standard is specific to communications to an aircraft cockpit display system. In addition, the management computer 14a, 14b does not generally have any outputs other than those provided for the links 16a and 17a (or 16b and 17b). There is therefore a need to transmit weather information from a weather radar to other aircraft systems, such as a recorder, an electronic flight bag (EFB), etc.

Moreover, under certain circumstances, it would be useful to be able to base the weather display in the cockpit not only on weather information from the weather radar, but also on weather information from other weather information sources, which is not possible with the weather information display system 40 of the prior art.

### SUMMARY

The disclosure herein is intended, in particular, to provide a solution to this problem. It relates to a weather information management system in an aircraft comprising:
a display system comprising at least one display screen in a cockpit of the aircraft and at least one display computer configured to control the display of information on the at least one display screen; and
at least one management computer of at least one aircraft weather radar, configured to receive data from the weather radar, to determine weather information to be displayed in the cockpit of the aircraft based on the data, and to send commands to display the weather information to the display system, in accordance with an ARINC 708 communication protocol,

the weather information management system being remarkable in that it further comprises a converter connected at its input to the at least one management computer of the at least one weather radar via at least one first link, and connected at its output to the display system via at least one second link, the converter being configured:
to receive the weather information display commands sent by the at least one management computer of the at least one weather radar via the at least one first link, in accordance with the ARINC 708 communication protocol;
to retransmit the weather information display commands via the at least one second link to the display system, in accordance with the ARINC 708 communication protocol;
to encapsulate the weather information display commands in data frames compliant with an Ethernet communication protocol; and
to send the data frames compliant with the Ethernet communication protocol via at least one third link to a user system on-board the aircraft.

For example, the converter is used to transmit weather information from an aircraft weather radar to systems other than the aircraft cockpit display system.

In particular, the user system corresponds to at least one of:
a flight data recorder of the aircraft;
a flight management system of the aircraft;
a radiocommunication system of the aircraft; an
EFB system on-board the aircraft;
a display system in the passenger cabin of the aircraft.

In one embodiment, the weather information management system further comprises a weather data fusion system connected at its input to at least one weather information source independent from the at least one weather radar, connected at its input to the converter via the at least one third link and connected at its output to the converter via a fourth Ethernet link, the weather data fusion system being configured:
to fuse weather information received from the at least one weather information source and weather information received from the converter;
to determine fused weather information display commands, in accordance with the ARINC 708 communication protocol, and to encapsulate these display commands in data frames compliant with an Ethernet communication protocol; and
to send the data frames compliant with the Ethernet communication protocol via the fourth link to the converter,

the converter being configured to de-encapsulate the fused weather information display commands contained in the data frames received from the fourth link, and to retransmit the fused weather information display commands via the at least one second link to the display system, in accordance with the ARINC 708 communication protocol.

In one embodiment, the converter is configured to monitor the reception, via the fourth link, of fused weather information from the weather data fusion system, over a predetermined time period, and:
if no fused weather information is received during the time period, to retransmit, via the at least one second link to the display system, the weather information display commands received from the at least one management computer of the at least one weather radar via the at least one first link, and
if fused weather information is received during the time period, to retransmit, via the at least one second link to the display system, the fused weather information display commands contained in the data frames received from the fourth link.

The disclosure herein also relates to a method for managing weather information in an aircraft which comprises a weather information management system, comprising:
a display system comprising at least one display screen in a cockpit of the aircraft and at least one display computer configured to control the display of information on the at least one display screen;
at least one management computer of at least one weather radar of the aircraft, configured to receive data from the weather radar, to determine weather information to be displayed in the cockpit of the aircraft based on the data, and to send commands to display the weather information to the display system, in accordance with an ARINC 708 communication protocol; and
a converter connected at its input to the at least one management computer of the at least one weather radar via at least one first link, and connected at its output to the display system via at least one second link.

The method comprises the following steps implemented by the converter:
receiving the weather information display commands sent by the at least one management computer of the at least one weather radar via the at least one first link, in accordance with the ARINC 708 communication protocol;
retransmitting the weather information display commands, via the at least one second link to the display system, to the display system, in accordance with the ARINC 708 communication protocol;
to encapsulate the weather information display commands in data frames compliant with an Ethernet communication protocol; and
to send the data frames compliant with the Ethernet communication protocol via at least one third link to a user system on-board the aircraft.

In particular, the user system corresponds to at least one of:
a flight data recorder of the aircraft;
a flight management system of the aircraft;
a radiocommunication system of the aircraft;
an EFB system on-board the aircraft;
a display system in the passenger cabin of the aircraft.

In one embodiment, the weather information management system further comprises a weather data fusion system connected at its input to at least one weather information source independent from the at least one weather radar, connected at its input to the converter via the at least one third link, and connected at its output to the converter via a fourth Ethernet link.

The method comprises the following steps implemented by the weather data fusion system:
fusing weather information received from the at least one weather information source and weather information received from the converter;
to determine fused weather information display commands, in accordance with the ARINC 708 communication protocol, and to encapsulate these display commands in data frames compliant with an Ethernet communication protocol; and
to send the data frames compliant with the Ethernet communication protocol via the fourth link to the converter,

and the following steps implemented by the converter:
de-encapsulating the fused weather information display commands contained in the data frames received from the fourth link; and
retransmitting the fused weather information display commands via the at least one second link to the display system, in accordance with the ARINC 708 communication protocol.

In one embodiment, the weather information management method comprises the following steps implemented by the converter:
monitoring the reception via the fourth link of fused weather information from the weather data fusion system over a predetermined time period; and
if no fused weather information is received during the time period, retransmitting, via the at least one second link to the display system, the weather information display commands received from the at least one management computer of the at least one weather radar via the at least one first link, or
if fused weather information is received during the time period, to retransmit, via the at least one second link to the display system, the fused weather information display commands contained in the data frames received from the fourth link.

The disclosure herein also relates to an aircraft comprising such a weather information management system.

### BRIEF DESCRIPTION OF THE DRAWINGS

The disclosure herein will be better understood upon reading the following description and with reference to the appended figures.

FIG. 1 shows an aircraft equipped with a weather information management system according to one embodiment of the disclosure herein.

FIG. 2, already described, shows schematically an example of a weather information management system of an aircraft according to the prior art.

FIG. 3 shows schematically a weather information management system according to an embodiment of the disclosure herein.

FIG. 4 shows a weather information management method according to an embodiment of the disclosure herein.

FIG. 5 shows a weather information management method according to an embodiment of the disclosure herein.

### DETAILED DESCRIPTION

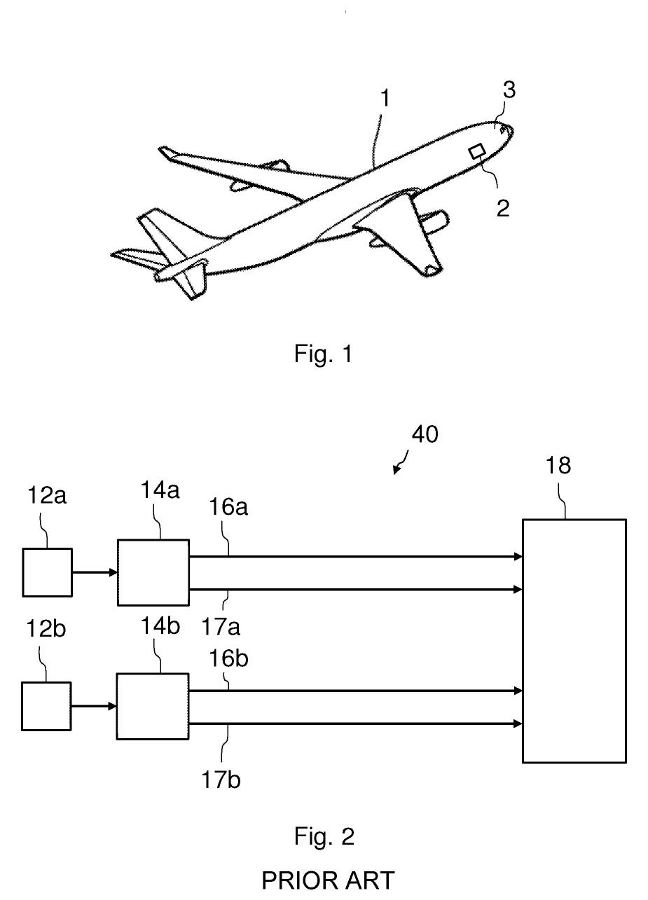

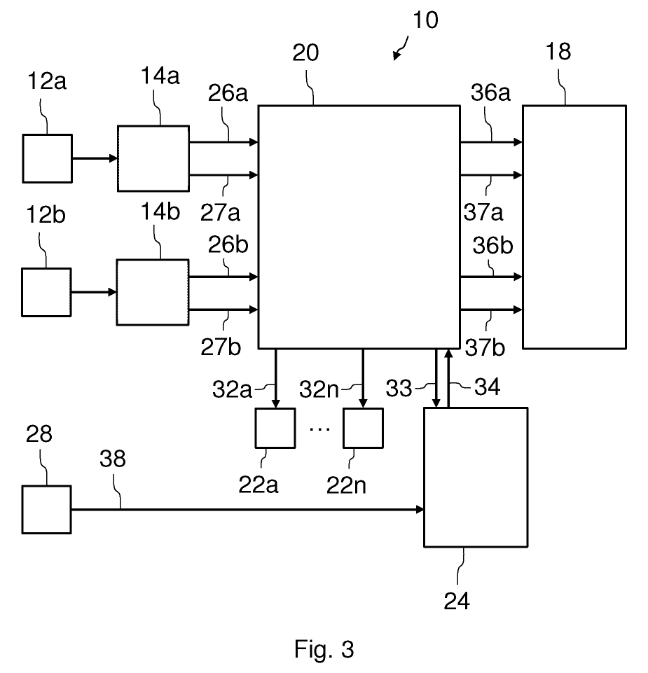

The aircraft 1 shown in FIG. 1 comprises a weather information display system 10 as shown in FIG. 3. The aircraft also comprises two weather radars 12a, 12b. The weather information management system 10 comprises a management computer 14a of the weather radar 12a, which is connected at its input to the weather radar 12a, and a management computer 14b of the weather radar 12b, which is connected at its input to the weather radar 12b. The weather information display system 10 also comprises a converter 20 and a display system 18 having at least one display screen in a cockpit 3 of the aircraft. The converter 20 is connected at its input to the management computer 14a of the weather radar 12a via two links 26a, 27a. The converter 20 is also connected at its input to the management computer 14b of the weather radar 12b via two links 26b, 27b. The converter 20 is connected at its output to the display system 18 via links 36a, 37a, 36b, 37b. The converter 20 is also connected at its output to at least one system 22a … 22n via at least one link 32a … 32n. The converter 20 and the computers 14a, 14b are, for example, located in an avionics bay 2 of the aircraft.

During operation, the management computer 14a of the weather radar 12a receives data from the weather radar 12a and consequently determines the weather information display commands that it transmits via the links 26a, 27a. The link 26a corresponds to display commands provided for a display unit dedicated to a pilot of the aircraft, and the link 27a corresponds to display commands provided for a display unit dedicated to a co-pilot of the aircraft. In the same way, the management computer 14b of the weather radar 12b receives data supplied by the weather radar 12b and consequently determines weather information display commands that it transmits via links 26b, 27b. The link 26b corresponds to display commands provided for a display unit dedicated to a pilot of the aircraft, and the link 27b corresponds to display commands provided for a display unit dedicated to a co-pilot of the aircraft. The computers 12a and 12b transmit display commands via links 26a, 27a, 26b, 27b using an ARINC 708 communication protocol. In the present description, the term "ARINC 708 communication protocol" means a communication protocol that conforms to the ARINC 708 or ARINC 708A standard, or to any subsequent version of the standard. According to a first alternative, the converter 20 corresponds to a dedicated avionics computer. According to another alternative, the converter 20 is integrated into an integrated modular avionics (IMA) modular avionics computer.

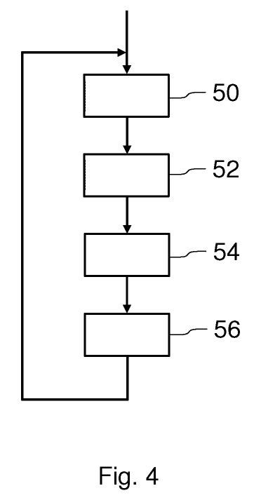

In a first step 50 of the method shown in FIG. 4, the converter 20 receives weather information display commands sent by the management computers 14a, 14b of the weather radars 12a, 12b via the respective links 26a, 27a, 26b, 27b, in accordance with the ARINC 708 communication protocol.

In a step 52, the converter 20 retransmits the weather information display commands via the respective links 36a, 37a, 36b, 37b to the display system 18, in accordance with the ARINC 708 communication protocol.

In a step 54, the converter 20 encapsulates the weather information display commands in data frames compliant with an Ethernet communication protocol.

In a step 56, the converter 20 sends the data frames compliant with the Ethernet communication protocol via at least one of the links 22a … 22n to at least one user system 32a … 32n on-board the aircraft.

Steps 50 to 56 are implemented repeatedly as the converter 20 receives weather information sent by the management computers 14a, 14b of the weather radars 12a, 12b. Although step 54 is shown after step 52 in FIG. 4, without departing the scope of the disclosure herein, step 54 can also be before step 52, or both steps can be concurrent.

In an embodiment, the at least one user system 32a … 32n is a flight recorder of the aircraft. The disclosure herein then records, in the flight recorder, information corresponding to the display of weather information on the display system 18 in the cockpit.

In an embodiment, the at least one user system 32a … 32n is an electronic flight bag (EFB). The disclosure herein then allows a software application installed in the EFB to display weather information. This may be useful, in particular, when the software application corresponds to an application provided to draw up a flight plan of the aircraft. The weather information display then allows a user to draw up a flight plan bypassing areas of turbulence.

In an embodiment, the at least one user system 32a … 32n is a flight management system (FMS) computer of the aircraft. The disclosure herein then allows the flight management computer to take into account weather information, for example, to draw up a flight plan bypassing areas of turbulence.

In an embodiment, the at least one user system 32a … 32n is an aircraft radiocommunication system (e.g. VHF, satellite, cellular, etc.). The disclosure herein then allows weather information to be sent to outside the aircraft, for example to be shared with other aircraft, with an air traffic control centre or a control centre of the airline operating the aircraft.

In an embodiment, the at least one user system 32a … 32n is a display system in the passenger cabin of the aircraft, for example an in-flight entertainment (IFE) system. The disclosure herein then allows passengers of the aircraft to view weather information.

In the embodiment shown in FIG. 3, the aircraft comprises two weather radars 12a and 12b. However, without departing the scope of the disclosure herein, the weather information management system 10 can be used with an aircraft comprising a different number of weather radars, for example, a single weather radar or more than two weather radars.

In the embodiment shown in FIG. 3, two links 26a, 27a and 26b, 27b respectively are provided between the weather radar management computer 14a, 14b respectively and the converter 20, and two links 36a, 37a and 36b, 37b respectively are provided between the converter 20 and the display system 18. Each time, one of the two links corresponds to the transmission of weather display commands intended for a display dedicated to the pilot, and the other of the two links corresponds to the transmission of weather display commands intended for a display dedicated to the co-pilot. Without departing the scope of the disclosure herein, a single link can be provided each time for the transmission of weather display commands intended for at least one display dedicated to the pilot and/or to the co-pilot.

In one particular embodiment, the weather information management system 10 further comprises a weather data fusion system 24. The weather data fusion system is connected at its input to at least one weather information source 28 independent from the at least one weather radar 12a, 12b. In particular, the at least one source of weather information 28 corresponds to an information source on-board the aircraft (e.g. a temperature sensor, pressure sensor, wind sensor, etc.), to a ground-based information source (for example a ground-based weather radar, temperature sensor, pressure sensor, wind sensor, etc.) or to an information source on-board a different aircraft. The weather data fusion system 24 is also connected at its input to the converter 20 via a third Ethernet link 33, similar to the third links 32a … 32n already described, and it is connected at its output to the converter 20 via a fourth Ethernet link 34.

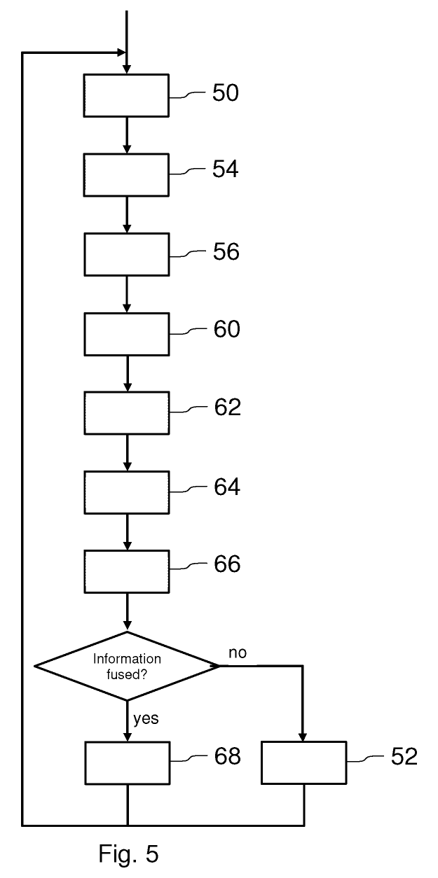

In a step 60, as shown in FIG. 5, the weather data fusion system 24 fuses weather information received from at least one weather information source 28 with weather information received from the converter 20. To do this, the weather data fusion system 24 receives the Ethernet data frames transmitted by the converter 20 via the third link 33 in step 56. It de-encapsulates the weather information display commands in accordance with the ARINC 708 communication protocol contained in the Ethernet frames and extracts the corresponding weather information. It fuses this weather information with weather information received from the at least one weather information source 28 in order to produce fused weather information. The data fusion method used for this purpose is not the subject of the disclosure herein. A person skilled in the art will use or adapt a common data fusion method for this purpose.

In step 62, the weather data fusion system 24 determines fused weather information display commands compliant with the ARINC 708 communication protocol, and then encapsulates these display commands in data frames compliant with an Ethernet communication protocol. In particular, the fused weather information display commands correspond to a fused weather information display for a geographical area at the front of the aircraft.

In step 64, the weather data fusion system 24 sends these data frames compliant with the Ethernet communication protocol via the fourth link 34 to the converter 20 which receives them.

In step 66, the converter 20 de-encapsulates the fused weather information display commands compliant with the ARINC 708 communication protocol, contained in the data frames received from the fourth link 34.

In step 68, the converter 20 retransmits these display commands via the at least one second link 36a, 37a, 36b, 37b to the display system 18, in accordance with the ARINC 708 communication protocol.

In this particular embodiment, in step 56, via at least one of the links 22a … 22n to at least one user system 32a … 32n on-board the aircraft, the converter 20 advantageously sends data frames compliant with the Ethernet communication protocol received from the weather data fusion system 24 in step 64.

In an embodiment, the converter 20 monitors the reception, via the fourth link 34, of fused weather information from the weather data fusion system over a predetermined time period. For example, this time period is a rolling time period. For example, the predetermined length of the time period is chosen in an interval [1 second; 1 minute]. If no fused weather information is received via the fourth link 34 during that time period, in the same way as already described in step 52, the converter retransmits, via the at least one second link 36a, 37a, 36b, 37b, to the display system 18, the weather information display commands received from the at least one management computer 14a, 14b of the at least one weather radar 12a, 12b via the at least one first link 26a, 27a, 26b, 27b. If fused weather information is received via the fourth link 34 during that time period, in a step 68, converter 20 retransmits, via the at least one second link 36a, 37a, 36b, 37b to the display system 18, the fused weather information display commands contained in the data frames received from the fourth link 34.

The weather information management system according to the disclosure herein offers the advantage that it can be implemented in an existing avionics architecture of an aircraft without requiring significant modifications to the architecture. Indeed, this implementation simply requires the converter 20 to be connected in series via the links between the weather radar management computers 14a, 14b and the display system 18. No modification is required to the weather radar management computers 14a, 14b, the display system 18 or other systems of the aircraft.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or "comprising" do not exclude other elements or steps, the terms "a", “an” or "one" do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for managing weather information in an aircraft, comprising:
a display system comprising at least one display screen in a cockpit of the aircraft, and at least one display computer configured to control display of information on the at least one display screen; and
at least one management computer of at least one weather radar of the aircraft, configured to receive weather radar data, to determine weather information to be displayed in the cockpit of the aircraft based on the data, and to send commands to display the weather information to the display system, in accordance with an ARINC 708 communication protocol;
the weather information management system comprising a converter connected at its input to the at least one management computer of the at least one weather radar via at least one first link, and connected at its output to the display system by at least one second link, the converter being configured:
to receive the weather information display commands sent by the at least one management computer of the at least one weather radar via the at least one first link, in accordance with the ARINC 708 communication protocol;
to retransmit the weather information display commands, via the at least one second link to the display system to the display system, in accordance with the ARINC 708 communication protocol;
to encapsulate the weather information display commands in data frames compliant with an Ethernet communication protocol; and
to send the data frames compliant with the Ethernet communication protocol via at least one third link, to a user system on-board the aircraft; and
the weather information management system further comprising a weather data fusion system connected at its input to at least one weather information source independent from the at least one weather radar, connected at its input to the converter via the at least one third link, and connected at its output to the converter via a fourth Ethernet link, the weather data fusion system being configured:
to fuse weather information received from at least one weather information source and weather information received from the converter;
to determine fused weather information display commands, in accordance with the ARINC 708 communication protocol, and to encapsulate these display commands in data frames compliant with an Ethernet communication protocol; and
to send the data frames compliant with the Ethernet communication protocol via the fourth link to the converter,
the converter being configured to de-encapsulate the fused weather information display commands contained in the data frames received from the fourth link, and to retransmit the fused weather information display commands via the at least one second link to the display system, in accordance with the ARINC 708 communication protocol.

2. The weather information management system according to claim 1, wherein the user system corresponds to at least one of:
a flight data recorder of the aircraft;
a flight management system of the aircraft;
a radiocommunication system of the aircraft;
an EFB system on-board the aircraft;
a display system in the passenger cabin of the aircraft.

3. The weather information management system according to claim 1, wherein the converter is configured to monitor reception, via the fourth link, of fused weather information from the weather data fusion system, over a predetermined time period, and:
if no fused weather information is received during the time period, to retransmit, via the at least one second link to the display system, the weather information display commands received from the at least one management computer of the at least one weather radar via the at least one first link; and
if fused weather information is received during the time period, to retransmit, via the at least one second link to the display system, the fused weather information display commands contained in the data frames received from the fourth link.

4. A method for managing weather information in an aircraft which comprises a weather information management system comprising:
a display system comprising at least one display screen in a cockpit of the aircraft and at least one display computer configured to control display of information on the at least one display screen;
at least one management computer of at least one weather radar of the aircraft, configured to receive weather radar data, to determine weather information to be displayed in the cockpit of the aircraft based on the data, and to send commands to display the weather information to the display system, in accordance with an ARINC 708 communication protocol; and
a converter connected at its input to the at least one management computer of the at least one weather radar by at least one first link, and connected at its output to the display system via at least one second link;
the method comprising steps implemented by the converter of:
receiving the weather information display commands sent by the at least one management computer of the at least one weather radar via the at least one first link, in accordance with the ARINC 708 communication protocol;
retransmitting the weather information display commands via the at least one second link, to the display system, in accordance with the ARINC 708 communication protocol);
encapsulating the weather information display commands in data frames compliant with an Ethernet communication protocol; and
sending the data frames compliant with the Ethernet communication protocol via at least one third link, to a user system on-board the aircraft;
the weather information management system further comprising a weather data fusion system connected at its input to at least one weather information source independent from the at least one weather radar, connected at its input to the converter via the at least one third link, and connected at its output to the converter via a fourth Ethernet link;
the method comprising seps implemented by the weather data fusion system of:
fusing the weather information received from the at least one weather information source and weather information received from the converter;
determining fused weather information display commands compliant with the ARINC 708 communication protocol, and encapsulating these display commands in data frames compliant with an Ethernet communication protocol; and
sending the data frames compliant with the Ethernet communication protocol via the fourth link to the converter,
and steps implemented by the converter of:
de-encapsulating the fused weather information display commands contained in the data frames received from the fourth link; and
retransmitting the fused weather information display commands via the at least one second link to the display system, in accordance with the ARINC 708 communication protocol.

5. The method for managing weather information according to claim 4, wherein the user system corresponds to at least one of:
a flight data recorder of the aircraft;
a flight management system of the aircraft;
a radiocommunication system of the aircraft;
an EFB system on-board the aircraft;
a display system in the passenger cabin of the aircraft.

6. The method for managing weather information according to claim 4, comprising steps implemented by the converter of:
monitoring reception, via the fourth link, of fused weather information from the weather data fusion system, over a predetermined time period; and
if no fused weather information is received during the time period, retransmitting, via the at least one second link to the display system, the weather information display commands received from the at least one management computer of the at least one weather radar via the at least one first link, or
if fused weather information is received during the time period, retransmitting, via the at least one second link to the display system, the fused weather information display commands contained in the data frames received from the fourth link.

7. An aircraft comprising the weather information management system according to claim 1.
